(19) United States
(12) Patent Application Publication
(10) Pub. No.: US 2010/0017219 A1
(43) Pub. Date: Jan. 21, 2010

(54) System and method for evaluating business compatibility

(76) Inventor: Matthew M. Busch, Atlanta, GA (US)

Correspondence Address: John Wiley Horton;Pennington, Moore, Wilkinson, Bell & Dunbar, P.A., 2nd Floor, 215 S. Monroe St., Tallahassee, FL, 32301, US

(21) Appl. No.: 12/218,797

(22) Filed: Jul. 18, 2008

(51) Int. Cl. G06Q 99/00; G06F 7/00; G06F 17/30

(52) U.S. Cl. 705/1; 707/104.1; 707/E17.009

(57) ABSTRACT

A system and method for evaluating the business compatibility between potential business associates. In order to perform such a function, information is first collected from many different parties who are seeking a business match. The user inputs various information, including but not limited to the identity of the user or organization, the location of the user or organization, the type of business associate sought, character features of the business associate sought, size of the organization, duration of the business relationship sought, the user's qualifications, the user's investment in the organization, the estimated total capital required to launch the project, and the amount of capital contribution an individual intends to provide toward the project. The collected information is inserted into a database for future reference. Once a user has input the information, the user may use the system to find and rank user's that are the best match to the user based on the information input by the user. The system helps match a user with potential business associates by computing a business compatibility score.

### CROSS-REFERENCES TO RELATED APPLICATIONS

Not Applicable.

### STATEMENT REGARDING FEDERALLY SPONSORED RESEARCH OR DEVELOPMENT

Not Applicable

### MICROFICHE APPENDIX

Not Applicable

### BACKGROUND OF THE INVENTION

1. Field of the Invention

This invention relates to the field of business transactions. More specifically, the present invention comprises a system and method for evaluating the business compatibility of two or more parties.

2. Description of the Related Art

Business professionals spend a substantial amount of time and energy locating and evaluating potential business associates. For example, when hiring an employee, a person or firm may first advertise that a position is vacant. The person or firm may then accept and review many job applications and/or resumes to identify individuals who would potentially be a good fit for the position. In many cases, the people applying for the vacant position do not really know if they are a good fit for the position because only a small amount of information may be provided about the position in the advertisement. The “best” applicants (determined by reviewing the resumes or job applications) are then interviewed before one of the applicants is offered a job.

This approach has many shortcomings. First, conventional job advertisements reach a limited audience. Potential applicants must monitor newspaper or Internet job listings at the time the opportunity is posted to discover the position vacancy. Second, potential applicants have difficulty discerning which vacancies are a good fit for their skill sets and interests. Also, some employers have difficulty discerning whether a potential applicant would be a good fit for the vacant position by evaluating the resume alone. Finally, the selection process for both parties involves subjective guesswork. Hiring decisions are inevitably based on criteria which may only indirectly relate to the potential applicants “fitness” for the job.

It has also become increasingly common for a business to seek out one or more other businesses for forming strategic partnerships or strategic alliances. These strategic partnerships and alliances are created in many ways. Most commonly, one business will identify a business need or opportunity and then research other firms which may be a good match for the need or opportunity. Once a potential partner has been identified, the potential partner is contacted and the two parties discuss the need or opportunity. It may take considerable time for the business seeking the partner to ultimately find the desired partner.

The process for finding a suitable business partner has many of the same shortcomings as the job search for an employee. It is generally difficult to ascertain whether there is a good “fit” between the partnering businesses until significant dialogue time is spent by both businesses. It would therefore be desirable to provide a system and method for evaluating the business compatibility between potential business associates that allows businesses to more quickly identify the most suitable business associate to fill a role.

### BRIEF SUMMARY OF THE INVENTION

The present invention is a system and method for evaluating the business compatibility between potential business associates. In order to perform such a function, information is first collected from many different parties who are seeking a business match. The user inputs various information, including but not limited to the identity of the user or organization, the location of the user or organization, the type of business associate sought, character features of the business associate sought, size of the organization, duration of the business relationship sought, the user's qualifications, the user's investment in the organization, the estimated total capital required to launch the project, and the amount of capital contribution an individual intends to provide toward the project. The collected information is inserted into a database for future reference. Once a user has input the information, the user may use the system to find and rank user's that are the best match to the user based on the information input by the user.

The system helps match a user with potential business associates by computing a business compatibility score. The compatibility score describes how closely the input parameters of a first party, P1, correlate to the input parameters of a second party, P2. Although both parties are searching for matches, the “compatibility score” reflects the matchability of the two parties from the perspective of the user for whom the search is being performed. In the preferred method, matchability is computed by comparing a series of “matches” between specified parameters of two projects, including “location,” “type,” “management,” and “magnitude.”

### BRIEF DESCRIPTION OF THE SEVERAL VIEWS OF THE DRAWINGS

FIG. 1 is an example of a graphical user interface.

FIG. 2 is an example of a graphical user interface.

FIG. 3 is an example of a graphical user interface.

FIG. 4 is an example of a graphical user interface.

FIG. 5 is an example of a graphical user interface.

FIG. 6 is an example of a graphical user interface.

FIG. 7 is an example of a graphical user interface.

FIG. 8 is a schematic, illustrating the present invention.

FIG. 9 is a schematic, illustrating the present invention.

REFERENCE NUMERALS IN THE DRAWINGS

| | | | |
|---|---|---|---|
| 10 | interface | 12 | name field |
| 14 | first location field | 16 | second location field |
| 18 | third location field | 20 | fourth location field |
| 22 | emphasis column | 24 | deselected icon |
| 26 | selected icon | 28 | type field |
| 30 | key word fields | 32 | age range drag bar |
| 34 | gender drag bar | 36 | personality drag bar |
| 38 | key word fields | 40 | degree field |
| 42 | experience field | 44 | membership drag bar |
| 46 | capital drag bar | 48 | timeline drag bar |
| 50 | my initial contribution drag bar | 52 | check box |
| 54 | my degree field | 56 | my experience field |
| 58 | key word fields | 60 | second type field |
| 62 | second degree field | 64 | third type field |
| 66 | second experience field | 68 | third experience field |
| 70 | radio buttons | 72 | template |
| 74 | P1 template data | 76 | database |
| 78 | matching interface | 80 | matching function |

### DETAILED DESCRIPTION OF THE INVENTION

The present invention is a system and method for evaluating the business compatibility between potential business associates. Business compatibility is determined by collecting information from the potential business associates and computing a compatibility score between two of the parties. The compatibility score is a function of the correlation of the information collected from the two parties.

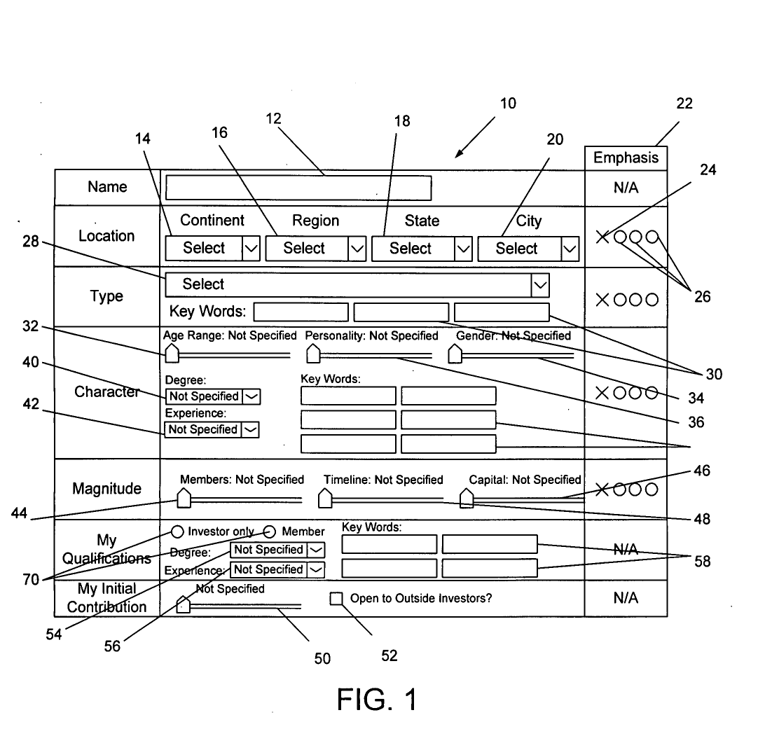

Because such a method is most easily implemented using a computer system, the following description and examples will focus on a computer-implemented method for determining business compatibility. The method requires the collection of certain information from potential business associates. The collection of the necessary information is best facilitated using a graphical user interface such as the one illustrated in FIG. 1. Interface 10 generally includes open input fields, drop-down boxes, drag bars, selectable icons, check boxes and radio buttons for inputting the information. These specific types of input mechanisms are representative of the types of mechanisms that may be used to capture the information, but are in no way exhaustive of the possibilities.

Name field 12 is used to input the name of the party inputting information into interface 10. First location field 14, second location field 16, third location field 18, and fourth location field 20 are used to input an increasingly precise identification of the party's location of interest. For example, first location field 14 may be used to select the continent of interest, and second location field 16 may be used to select the region of interest on the selected continent. The selectable options in second location field 16 are limited to those that are available based on the user's selection in first location field 14. Third location field 18 allows the user to select a state of interest within the region selected in second location field 16. Finally, the user can select a city of interest using fourth selection box 20 based upon the selected state of interest in third location field 18. This location of interest may be the place where the party is located or the location where a project is to be performed.

Once location information is input into interface 10, the user will input information about the nature of the project or the nature of the position for which a business associate is sought. Type field 28 is used to select or input the nature of the project or the nature of the position. Key word fields 30 are open fields available for inputting “search terms” which the user believes succinctly describe the position or project.

The user then inputs information regarding the nature of the business associate sought to fill the position. Age range drag bar 32 may be used to select the desired age range of the business associate sought if age is a consideration for the position. If age is not a consideration for the position, age range drag bar 32 may be left at the default position shown in FIG. 1 to indicate that the age range is not specified. Personality drag bar 36 is provided to enable the user to select a desired personality type. Personality type may be presented in various ways including Myers-Briggs type indicators. Gender drag bar 34 may also be used to select the desired gender of the business associate. Gender drag bar 34 and personality drag bar 36 may be left in the default position (shown in FIG. 1) if gender and personality are not considerations for the position. Degree field 40 and experience field 42 are provided to input degree and experience requirements or preferences for the position. Key word fields 38 are open fields where the user can input the desired qualities which the user would like to employ as “search terms.”

The user then inputs information regarding the “magnitude” of the project or position. Membership drag bar 44 may be used to indicate the membership size of the organization or project. Timeline drag bar 48 may be used to indicate the intended duration of the position or project. Capital drag bar 46 may be used to indicate the estimated total capital required to launch the project.

The user then inputs information about the user's qualifications. Radio buttons 70 are provided for the user to indicate whether he or she is acting only as a financing investor or whether he or she will be an active member of the project or play a role in the hiring organization. My degree field 54 and my experience field 56 are provided for inputting the user's degree and experience. Key word fields 58 are provided for inputting qualities of the user that the user believes are significant to his or her role in the organization or project. The user may then input information about his or her investment in the organization or project using my initial contribution drag bar 50. Check box 52 is provided so that the user can indicate whether he or she is open to outside investors.

Emphasis column 22 is provided for indicating the relative importance of the various criteria input regarding location, type, character, and magnitude. The user can input the relative importance by selecting or deselecting icons in emphasis column 22 next to the input criteria. In this example, deselected icons 24 are shown as “X” and selected icons 26 are shown as circles. If each criteria is of equal value to the user, each criteria should have the same quantity of selected icons 26. If one criteria is more important than the others, it should have more selected icons 26 than the other criteria. Insignificant criteria should have fewer selected icons 26 than significant criteria. The icons of interface 10 may be selected or deselected by using a computer mouse to move the cursor over the icon and then clicking on the appropriate button on the mouse.

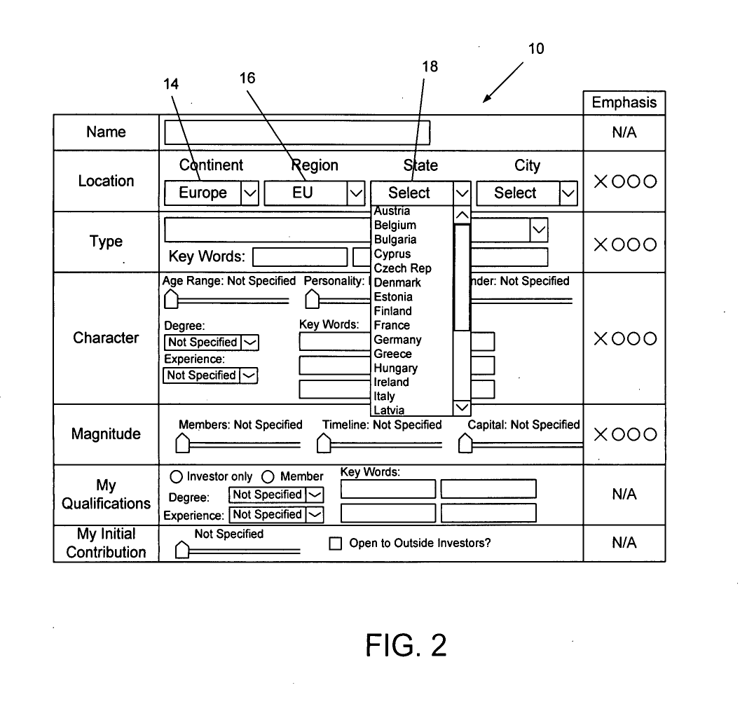

Turning to FIG. 2, the user will observe that the selectable options provided in drop-down type list boxes are affected by previous selections. In this example, the user selected “Europe” as the continent of interest in first location field 14. Of the various European regions provided in second location field 16, the user selected “EU” for European Union. The countries of the European Union are then listed in third location field 18.

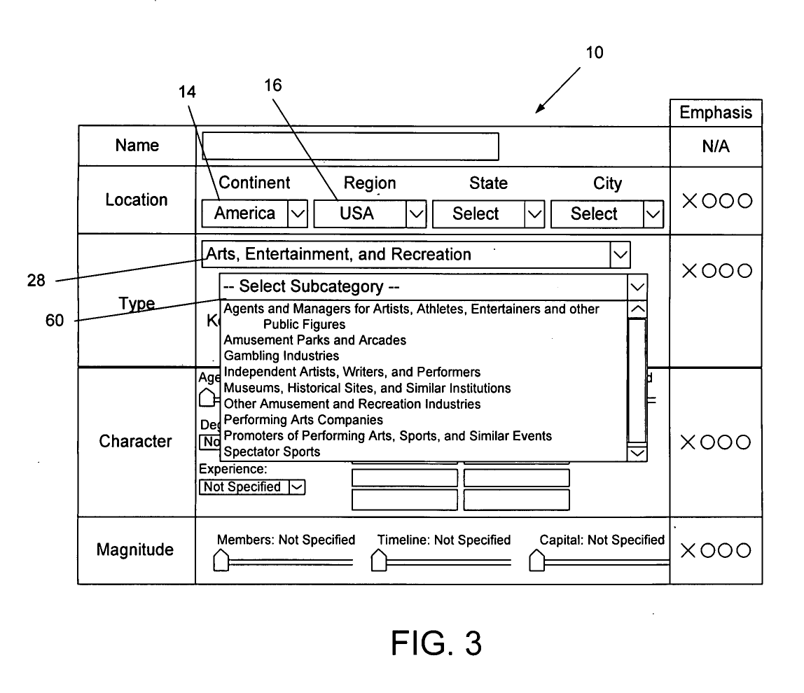

As shown in FIG. 3, a similar presentation may be used for describing the nature of the position or project with an increasing level of specificity. In this example, the user selected “America” in first location field 14 and “USA” in second location field 16. The user elected to not describe the location at a higher level of specificity. In type field 28, the user selected “Arts, Entertainment, and Recreation.” The system then automatically generated second type field 60 in interface 10 so the user can choose a more specific description of the nature of the project and position from the subcategories of “Arts, Entertainment, and Recreation” that are listed.

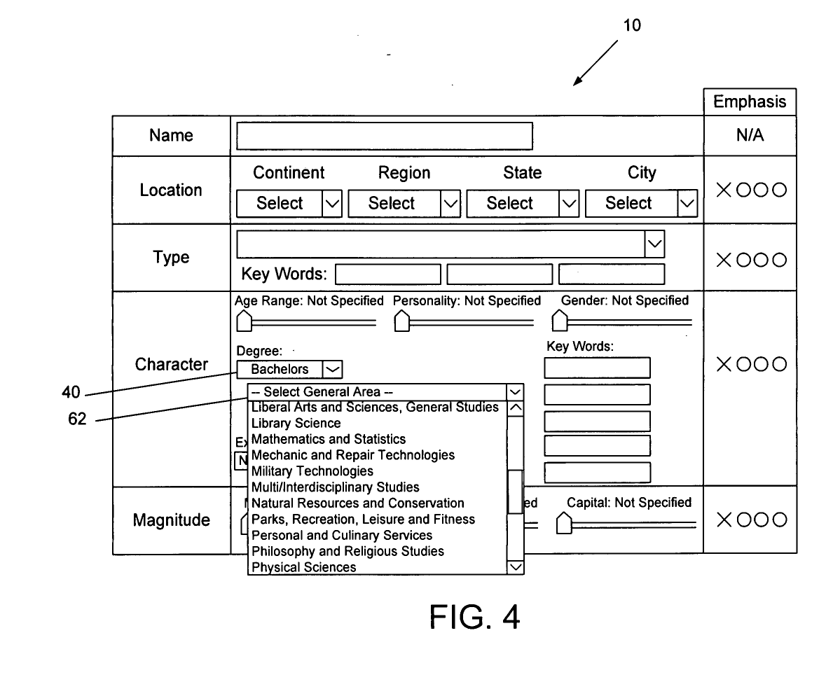

A similar presentation may also be used for the other input fields of interface including character information fields as illustrated in FIG. 4. In this example, the user selected “Bachelors” in degree field 40. The system then automatically generated second degree field 62 in interface 10 so the user can choose a more specific description of type of degree sought from the subcategories of “Bachelors” that are listed.

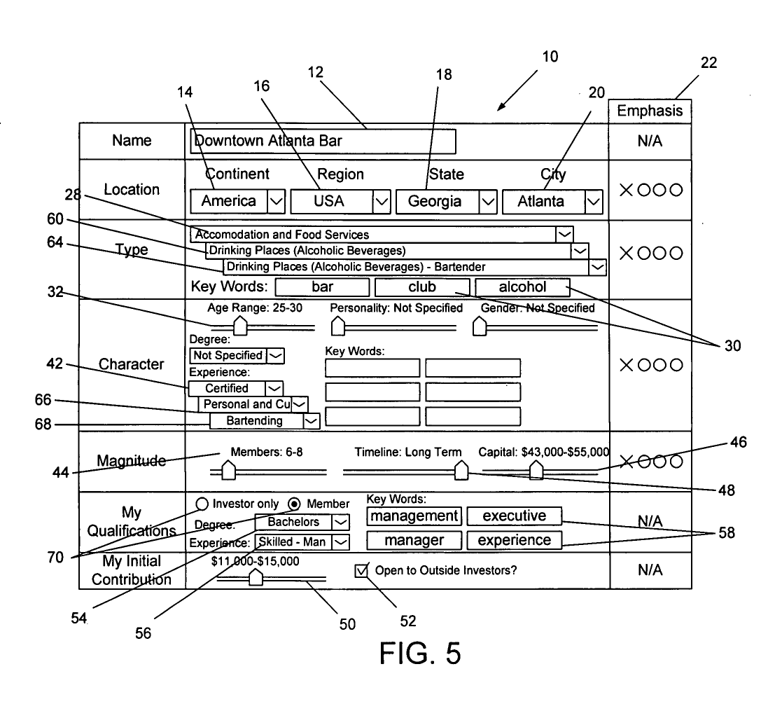

FIGS. 5-7 are examples of completed “templates.” FIG. 5 shows an example of what a completed template might look like for a bar proprietor interested in hiring a bartender. The proprietor input the name of the bar “Downtown Atlanta Bar” in name field 12, and made the appropriate selections in first location field 14, second location field 16, third location field 18, and fourth location field 20 to indicate that the opportunity is available in Atlanta, Ga. The proprietor then successively selected “Accommodation and Food Services,” “Drinking Places (Alcoholic Beverages),” “Drinking Places (Alcoholic Beverages)—Bartender” in type field 28, second type field 60, and third type field 64 to indicate that the proprietor is interested in hiring a bartender. The proprietor chose the search terms “bar,” “club,” and “alcohol” in key word fields 30.

Regarding the character of the bartender sought, the proprietor adjusted age range drag bar 32 to indicate that the proprietor is interested in hiring someone in the 25-30 year age range. The proprietor has also indicate that they are interested in a bartender that has received certification in bartending by making the appropriate selections in experience field 42, second experience field 66 and third experience field 68.

The proprietor then inputted information regarding the nature of the organization. The proprietor adjusted membership drag bar 44, timeline drag bar 48 and capital drag bar 46 to indicate that the membership of the organization is the range of 6-8 people, that the duration of the position is “long term” and that the expected total capital required to launch the project is in the range of $43,000-$55,000. The proprietor indicated that he or she is a member of the organization by selecting the appropriate radio button 70 and indicated that he or she has a Bachelors degree and is a “skilled” manager using my degree field 54 and my experience field 56, respectively. The proprietor also completed key work fields 58 with search terms that the proprietor believes accurately describe himself or herself. The proprietor further indicated that his or her initial contribution as in the range of $11,000 to $15,000 using my initial contribution drag bar 50 and selected check box 52 to indicate that the proprietor is open to outside investors. The proprietor's selections in emphasis column 22 indicate that the proprietor considers each criteria of equal importance.

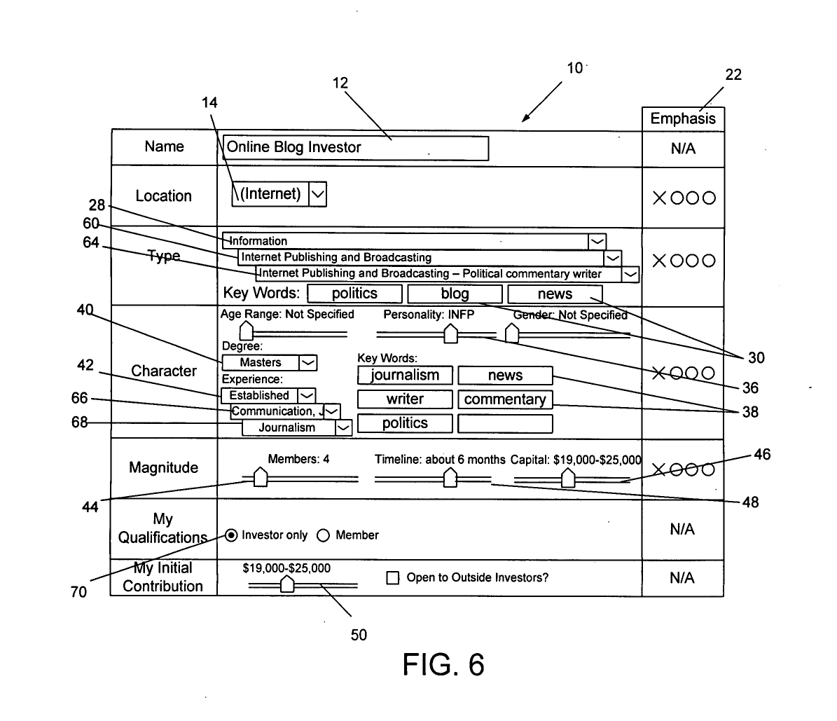

FIG. 6 shows an example of what a completed template might look like for an investor seeking a writer to provide political commentary on an internet website. The investor input the name of the “Online Blog Investor” in name field 12, and selected “Internet” in first location field 14. Because the work can be performed from any location, no other location fields need be completed. The investor then successively selected “Information,” “Internet Publishing and Broadcasting,” “Internet Publishing and Broadcasting—Political commentary writer” in type field 28, second type field 60, and third type field 64 to indicate that the investor is interested in a political commentary writer. The investor chose the search terms “politics,” “blog,” and “news” in key word fields 30.

Regarding the character of the writer sought, the investor adjusted personality drag bar 32 to indicate that the Meyers-Briggs personality type INFP is preferred. The investor has also indicated that they are interested in a writer who has received a masters degree and has “established” level experience in the field of journalism by making the appropriate selections in experience field 42, second experience field 66 and third experience field 68.

The investor then input information regarding the nature of the organization. The investor adjusted membership drag bar 44, timeline drag bar 48 and capital drag bar 46 to indicate that there are 4 members in the organization, that the duration of the position is “about 6 months” and that the expected total capital required to launch the project is in the range of $19,000-25,000. The investor indicated that he or she is only an investor in the organization by selected the appropriate radio button 70. The investor further indicated that his or her initial contribution as in the range of $19,000 to $25,000 using my initial contribution drag bar 50. The investor's selections in emphasis column 22 indicate that the investor considers each criteria of equal importance.

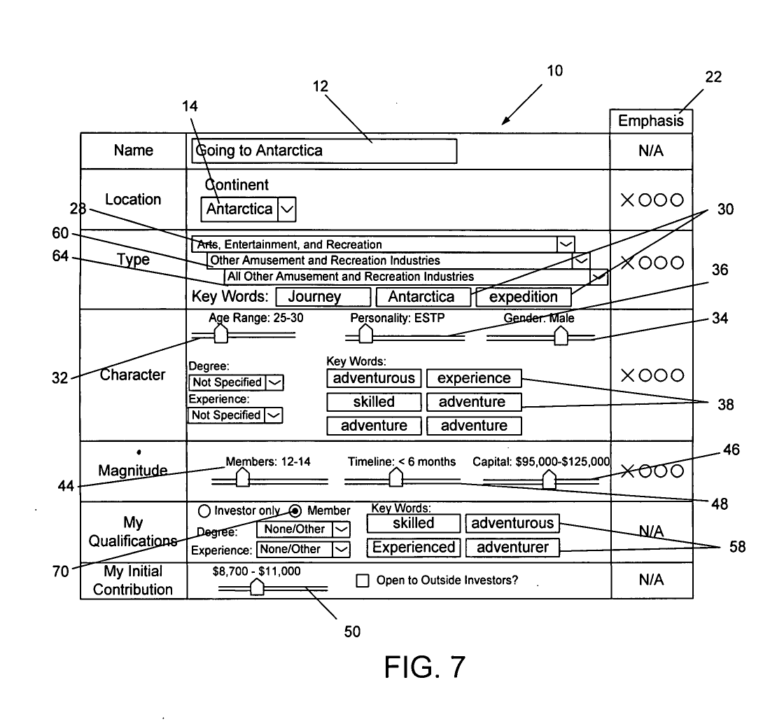

FIG. 7 shows an example of what a completed template might look like for a member of a expedition team who is seeking a team member to join the team on an expedition to Antarctica. The team member input the name of the group as “Going to Antarctica” in name field 12, and selected “Antarctica” in first location field 14. Because the system contains no more specific designations for regions within Antarctica, second location field 16, third location field 18, and fourth location field 20 are not generated by the selection of “Antarctica.” The team member then successively selected “Arts, Entertainment, and Recreation,” “Other Amusement and Recreation Industries,” “All Other Amusement and Recreation Industries” in type field 28, second type field 60, and third type field 64. The proprietor chose the search terms “journey,” “Antarctica,” and “expedition” in key word fields 30.

Regarding the character of the bartender sought, the team member adjusted age range drag bar 32, personality drag bar 36, and gender drag bar 34 to indicate that the proprietor is interested in hiring a male in the 25-30 year age range with an ESTP Meyers-Briggs type personality. The team member input the key words “adventurous, “skilled,” “experience” and the word “adventure” three times in key word fields 38.

The team member then inputted information regarding the nature of the organization. The team member adjusted membership drag bar 44, timeline drag bar 48 and capital drag bar 46 to indicate that the membership of the organization is the range of 12-14 people, that the duration of the position is “less than 6 months” and that the expected total capital required to launch the project is in the range of $95,000-125,000. The team member indicated that he or she is a member of the organization by selected the appropriate radio button 70. The team member also completed key work fields 58 with search terms that the proprietor believes accurately describe himself or herself. The team member further indicated that his or her initial contribution as in the range of $8,700 to $11,000 using my initial contribution drag bar 50. The team member's selections in emphasis column 22 indicate that the team member considers each criteria of equal importance.

The foregoing examples illustrate that the proposed system is flexible and may accommodate many diverse business match requests. It is contemplated that over time a database would be populated with many completed templates as various users input and submit completed templates to the system. Once multiple completed templates have been provided to the system, the system can compute “compatibility” scores between the users. Before the process for determining compatibility is described in significant detail, it may be helpful to understand what the “compatibility score” describes.

The compatibility score describes how closely the input parameters of a first party, P1, correlate to the input parameters of a second party, P2. Although both parties are searching for matches, the “compatibility score” reflects the matchability of the two parties from the perspective of the user for whom the search is being performed. The term “project” refers to a sum of data compiled from a user's input which are saved to the user's profile in the system. For simplicity, P1 will refer to the project whose parameters are primary to the calculation of matchability, and P2 will refer to the project that is currently being matched against P1.

It should be noted that while one user may see a match for his project in another user, the reverse is not necessarily true. For example, one user may be a director seeking a 70-year-old man to play a part in a film, while a 70-year-old man is seeking to edit film rather than act in it. There may be a 90% match when P1 is the director and P2 is the 70-year-old man, but only a 60% match when P1 is the 70-year-old man and P2 is the director.

Although various computational methods may be used to calculate a compatibility score, a preferred method is disclosed herein. In the preferred method, matchability is computed by comparing a series of “matches” between specified parameters of two projects, including “location,” “type,” “management,” and “magnitude.” The matchability of two projects—a final percentage score—is then computed by dividing a “Current Score” by a “Max Score.” “Current Score” is a simple sum, starting at zero (0), with greater or fewer points being added to it as matches between the parameters of the two projects are made. “Max Score” is more static, starting with a value of three hundred (300) and being added to only in special cases, such as when a user wishes to add weight or emphasis to certain matches. In some cases “Max Score” may be subtracted from as well. This computational variation may be particularly useful when a user leaves one or more of the fields blank.

As mentioned previously, the parameters may be grouped into four main categories: Location, Type, Management, and Magnitude. The “Location” category consists only of the specified location of a project. As illustrated in FIGS. 1-7, “Location” includes the “Continent,” “Region,” “State” and “City.” The location of the project is as specific as the user allows, and more specific matches produce a higher matchability rating. For a continental match between two projects, the matchability score increases; further increases occur by country matches, state matches, and city matches.

The “Type” category consists of both the specified type of a project and a series of optional key words that user may enter as descriptors of the project. As illustrated in FIGS. 1-7, the type of the project is input by the user in type field 28, second type field 60, and third type field 60. The optional key words are input into key word fields 30. As with the Location category, the matchability rating between two projects increases incrementally as a more specific Type match is found. Broad categorical matches produce some increase in matchability, whereas more specific matches produce greater matchability scores. Various numbers of key word fields may be provided. In the illustrated examples, three (3) are provided. It is preferred, however, for five (5) fields to be provided. If five fields are provided, the user can enter up to five key words. These words of P1 are matched individually against the same key words of P2, and each match produces a slightly higher matchability score.

The “Management” category consists of the desired qualities of the business associate sought for the project. As illustrated in FIGS. 1-7, these qualities include Age Range, Personality Type, Gender, Degree, Experience, and optional Key Words. The Age Range parameter ranges from sixteen to over eighty years old, and is divided into nine smaller increments (e.g., 20-24, 25-30, etc.). Matches produce a greater or smaller increase in matchability depending on the nearness or proximity of the match.

The “Personality Type” category consists of sixteen personality types specified by the Myers-Briggs type indicator. Each of these types consists of four letters, and each letter taken from a pair of dichotomies. Thus the “ESTP” personality is the opposite of the “INFJ,” while “ENTJ” is opposite of “ISFP.” Thus, matchability may be determined for each letter of P2's personality that matches the personality P1 desires for that position.

The “Gender” parameter consists of two genders, male and female. Matchability increases for a specific gender match. As with “Age Range” and “Personality Type,” a user may choose not to specify his or her own gender, that of the candidate they seek, or both. In the case of unspecified parameters, some points are added to the Current Score insofar as a match is statistically likely.

The “Degree” parameter consists of three listings. The first list indicates the degree of education. This list includes “Associates,” “Bachelors,” “Masters,” and “Doctorate.” The user then specifies the area in which the degree lies by selecting a category and subcategory. Points are added to the Current Score according to both the proximity of the degree level matched and the proximity of the area in which that degree lies.

The “Experience” parameter operates in the same way as the Degree parameter. Instead of a list of degrees, however, is a list of competence levels, which include the terms “Skilled,” “Trained,” “Certified,” and “Established.” The lists provided for specifying an area in which that competence lies are the same as the lists specifying an area in which a user has obtained an educational degree. Again, points are added to the Current Score according to both the proximity of the competence level matched and the proximity of the area in which that competence lies.

The optional Key Words operate in the exact same way as they do in the Type category referenced previously, except that the Management key words of P1 are matched against the Personal Qualifications—rather than Management—key words of P2.

The Magnitude category consists of three parameters which include the initial number of members, timeline, and initial capital required. Each of the parameters operates in the same way as the “Age Range” parameter in the calculation of the Current Score, except that the increments differ in number and range.

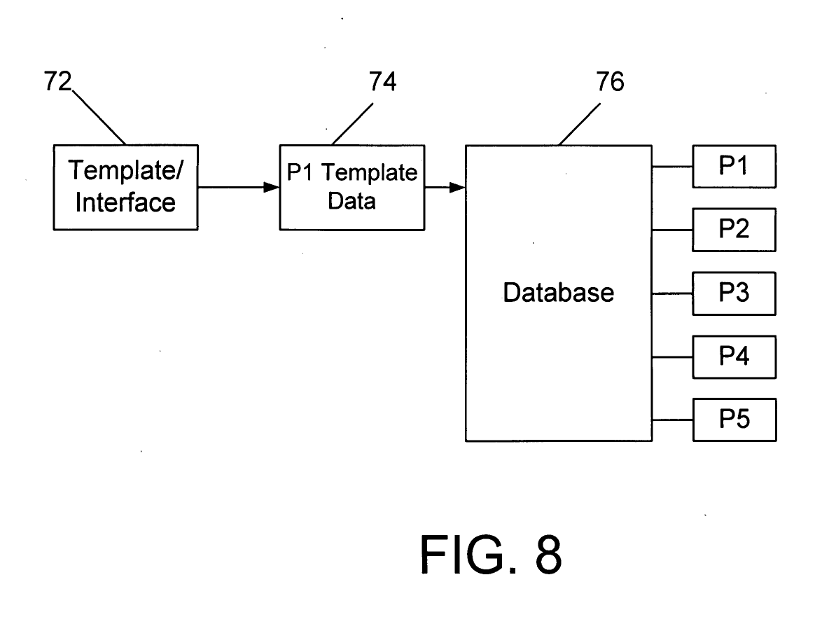

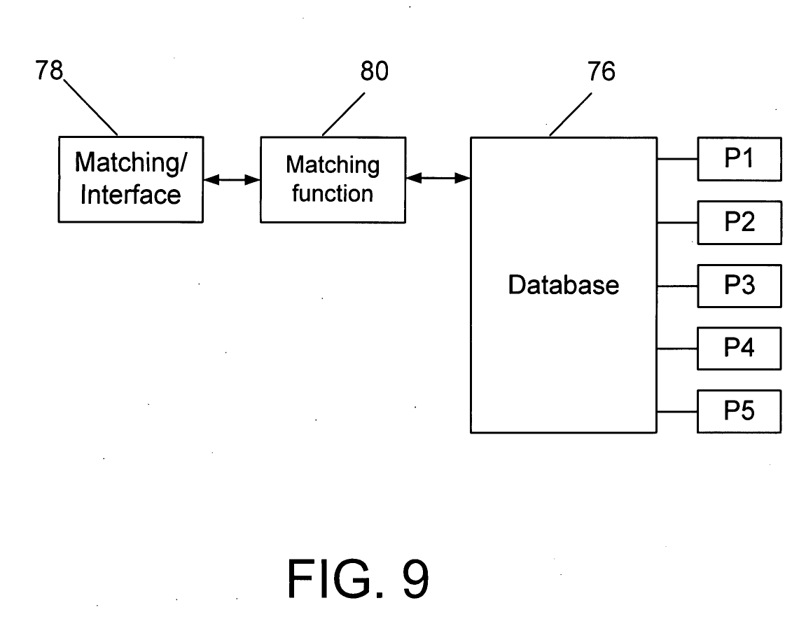

Although there are many ways that a computer system may be configured to collect the information from the parties and use such information to compute the compatibility score for two potential business associates, FIGS. 8 and 9 are illustrative of one such system. As shown in FIG. 8, template 72, which is a graphical user interface, is displayed to the user, P1. Once the user has completed the template, the system extracts P1 template data 74 input by the user into template 72 and inserts P1 template data 74 into database 76. Database 76 stores the template data for various users, including P1, P2, P3, P4, and P5.

Because P1 has input the template data into the system, P1 may now use the system to find the “best match” for the business associate sought as shown in FIG. 9. P1 accesses matching interface 78 and commands the system to list potential business associates that most closely match the project data P1 entered into the system when completing template 72. The system performs matching function 80 using the project data entered by P1, P2, P3, P4, and P5 stored in database 76. Matching function 80 simply computes the compatibility score for P1 as described previously. The system then lists P2, P3, P4, and P5 in order based on how the project data matches the project data of P1.

The preceding description contains significant detail regarding the novel aspects of the present invention. It should not be construed, however, as limiting the scope of the invention but rather as providing illustrations of the preferred embodiments of the invention. Thus, the scope of the invention should be fixed by the following claims, rather than by the examples given.

Having described my invention, I claim:

1. A method for evaluating business compatibility between a first party and a second party comprising:
a. providing a first template to be completed by said first party;
b. collecting a first set of information regarding said first party, said first set of information input by said first party using said first template, said first set of information describing desired features of a business associate sought for a business relationship with said first party;
c. providing a second template to be completed by said second party;
d. collecting a second set of information regarding said second party, said second set of information input by said second party using said second template, said second set of information describing features of said second party; and
e. computing a compatibility score relating to said first party and said second party for said first party, said compatibility score correlating how closely said second set of information matches said first set of information.

2. The method of claim 1, further comprising the step of recording said first set of information and said second set of information in a database.

3. The method of claim 1, further comprising the step of computing a compatibility score relating to said first party and said second party for said second party, said compatibility score correlating how closely said first set of information matches said second set of information.

4. The method of claim 1, wherein said first set of information includes a first location of said first party and said second set of information includes a second location of said second party.

5. The method of claim 4, wherein said compatibility score is a function of the geographic proximity of said first location to said second location.

6. The method of claim 1, wherein said compatibility score is a function of the closeness of the education and experience of said second party to the education and experience desired in said business associate as indicated in said first set of information provided by said first party.

7. The method of claim 1, wherein said compatibility score is a function of the closeness of the type of business relationship sought by said sought by said first party and the type of business relationship sought by said second party.

8. The method of claim 1, wherein said compatibility score improves as a more specific match is made within a category.

9. The method of claim 1, said first set of information further including information describing said first party.

10. The method of claim 1, wherein said compatibility score is a function of a first set of qualifications of said second party to a second set of qualifications desired in said business associate as indicated in said first set of information provided by said first party.

11. The method of claim 2, said database containing records of additional sets of information input by additional parties.

12. The method of claim 11, further comprising the step of computing a plurality of compatibility scores for said first party, each of said plurality of compatibility scores correlating how closely one of said additional sets of information matches said first set of information.

13. A computerized system for evaluating business compatibility between a first party and a second party comprising:
a. a first template to be completed by said first party, said first template having fields for inputting a first set of information describing features of a business associate sought for a business relationship with said first party;
b. a second template to be completed by said second party, said second template having fields for inputting a second set of information describing features of said second party;
c. wherein said computerized system configured to record said first set of information after said first set of information is input by said first party using said first template and record said second set of information after said second set of information is input by said second party using said second template; and
d. wherein said computerized system is configured to compute a compatibility score relating to said first party and said second party for said first party, said compatibility score correlating how closely said second set of information matches said first set of information.

14. The computerized system of claim 13, wherein said first set of information includes a first location of said first party and said second set of information includes a second location of said second party.

15. The computerized system of claim 13, wherein said compatibility score is a function of the geographic proximity of said first location to said second location.

16. The computerized system of claim 13, wherein said compatibility score is a function of the closeness of the education and experience of said second party to the education and experience desired in said business associate as indicated in said first set of information provided by said first party.

17. The computerized system of claim 13, wherein said compatibility score is a function of the closeness of the type of business relationship sought by said sought by said first party and the type of business relationship sought by said second party.

18. The computerized system of claim 13, wherein said compatibility score improves as a more specific match is made within a category.

19. The computerized system of claim 13, said first set of information further including information describing said first party.

20. The computerized system of claim 13, wherein said compatibility score is a function of a first set of qualifications of said second party to a second set of qualifications desired in said business associate as indicated in said first set of information provided by said first party.
